(19) United States
(12) Patent Application Publication
(10) Pub. No.: US 2008/0236736 A1
(43) Pub. Date: Oct. 2, 2008

(54) Image Forming Apparatus, Image Forming System, Paper Feeding Apparatus, Image Recording Medium, And Method Of Manufacturing Image Recording Medium

(76) Inventors: Reki Nakamura, Kanagawa (JP); Mikio Ishibashi, Kanagawa (JP); Kazuhisa Sudo, Kanagawa (JP); Megumi Ohtoshi, Kanagawa (JP); Masafumi Yamada, Kanagawa (JP); Toshihiro Sugiyama, Tokyo (JP); Takeo Suda, Kanagawa (JP); Yukiko Iwasaki, Kanagawa (JP); Nobuyuki Koinuma, Kanagawa (JP); Takashi Sakamaki, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/994,428

(22) PCT Filed: Jan. 11, 2007
(86) PCT No.: PCT/JP2007/050621

§ 371 Date: Jan. 2, 2008

(30) Foreign Application Priority Data
Jan. 17, 2006 (JP) 2006-008207
Feb. 3, 2006 (JP) 2006-026601
Feb. 3, 2006 (JP) 2006-027582

(51) Int. Cl. B32B 38/14; B32B 7/12; G03G 15/00

(52) U.S. Cl. 156/277; 428/343; 156/387; 399/45

(57) ABSTRACT

A recording medium is conveyed through a conveyer path. A recording-medium selecting unit selects either one of a non-transparent recording medium and a transparent recording medium, and conveys a selected recording medium to the conveyer path. An image selecting unit selects an image to be formed on the recording medium from among an original image and a reversed image obtained by reversing the original image. A control unit controls, based on a control signal, the recording-medium selecting unit and the image selecting unit.

### TECHNICAL FIELD

The present invention relates to an image forming apparatus, an image forming system, a paper feeding apparatus, an image recording medium, and a method of manufacturing image recording medium, and more particularly, to an image forming apparatus, an image forming system, a paper feeding apparatus, an image recording medium, and a method of manufacturing the image recording medium, with a capability of automatically reversing an original image on a transparent recording medium.

### BACKGROUND ART

Conventionally, to obtain glossy images with photographic image quality, various attempts have been made. For example, in Japanese Patent Application Laid-Open No. 2002-341623, special toner for a gloss is used. After normal image formation is performed on a sheet and before the sheet goes to a fixing unit, transparent toner is evenly formed on the entire surface and is fixed, thereby obtaining photographic image quality. However, this technology has problems, such that transparent toner is always evenly supplied to the entire surface and the load on the fixing unit is high due to a difference in toner thickness between an image portion and a non-image portion.

In Japanese Patent Application Laid-Open No. 2004-191678, a special recording medium is used for a gloss. A thermoplastic resin layer is provided on the front and back sides of a sheet and, after an image is normally fixed, pressure and heat are further added, thereby achieving an even gloss on the surface. However, to use this technology, a special fixing device has to be used together for achieving effects, thereby posing problems in configuration, cost, power consumption, and other points.

Furthermore, in Japanese Patent Application Laid-Open No. 2003-270991, a special fixing device is used for a gloss. After normal fixing (first fixing), a second fixing unit formed of a high-smooth belt is provided to again melt the toner, and then cooling and exfoliation are performed. By using the smoothness of the belt, an even gloss can be obtained. As with the second patent document, there are problems in configuration, cost, power consumption, and other points.

Moreover, in Japanese Patent Application Laid-Open No. 2001-305894, a cooling unit is placed inside a fixing roller. With this, when the toner on the sheet reaches at a point equal to or lower than its softening point or melting point, it is peeled off by the fixing roller. On the toner surface, a color image and a matted image can be obtained. In this scheme, however, since the cooling unit is placed inside the fixing roller, adverse effects are thought to occur, such as complexity of the apparatus and high cost.

For the purpose of improve keeping quality or the like, there is a laminator for protection against disturbance by catching the document by a transparent medium. However, the laminator does not have a function of improving image quality, and an image with high image quality is not necessarily obtained.

In a convention technology disclosed in Japanese Patent Application Laid-Open No. 2000-321842, a detection sensor that detects reflected light from a recording medium is provided at a position on an upstream side in a direction in which resist rollers convey the recording medium and, based on the detection result of the detection sensor, the type of the recording medium is identified.

Furthermore, in Japanese Patent Application Laid-Open No. 2005-10529, a recording medium having a transparent part and a non-transparent part is disclosed.

Conventionally, to obtain glossy images with photographic image quality or other purposes, various attempts have been made.

As an example of the image forming apparatus, a color image forming apparatus has been disclosed that includes: an intermediate transfer member on which color toner images of plural different colors are transferred from at least one image carrier in a multiplexing manner; a transparent toner developing unit that develops transparent toner; a second transferring unit that transfers the color toner images formed on the intermediate transfer member and a transparent toner image onto a transfer member; and a fixing unit that fixes the color toner images and the transparent toner image formed on the transfer member onto the transfer member (see, for example, Japanese Patent Application Laid-Open No. 2002-341623).

As an example of the recording medium, there is an image receiving sheet for electrophotography having a toner image receiving layer on one surface of a supporting member and a back layer on the other surface thereof, in which the supporting member has a thermoplastic resin layer on one surface or both surfaces of a base, a binder on the top surface layer on the toner image receiving layer side and the top surface layer on the back layer side is soap-free-type water-dispersible polymer having a glass transition temperature (21 grams) of 20 to 80 degrees Celsius, and at least either one of the toner image receiving layer side and the back layer contains a high-polymer-system anti-static agent (see, for example, Japanese Patent Application Laid-Open No. 2004-191678).

As for a fixing unit, there is an example of the image forming apparatus including a plurality of fixing units, that is, a first fixing unit and a second fixing unit (see, for example, see Japanese Patent Application Laid-Open No. 2003-270991).

There is an example of an image display plate, in which an optical retroreflection sheet is provided correspondingly to a transparent film, a print surface on which a reversed image is printed on the back side of the transparent film, and a print surface of the transparent film; also a bonding surface is provided correspondingly to a surface corresponding to the print surface of the optical retroreflection sheet; and both are combined and integrated (see, for example, Japanese Patent Application Laid-Open No. 2001-305894).

However, in the conventional technologies explained in the documents, as explained above, the conventional image forming apparatus forms and outputs an image input from a user without reversing the image unless particularly instructed from the user. According to the present invention, since the configuration is such that an image is formed on a transparent recording medium and is viewed from the back, the image is required to be formed as being reversed onto the transparent recording medium.

Furthermore, in the conventional technology disclosed in Japanese Patent Application Laid-Open No. 2000-321842, the detection sensor is provided at a position on an upstream side in a direction in which resist rollers convey the recording medium. Therefore, there is a problem in which, due to a difference in slack of the recording medium in a nip between the resist rollers and a slanting shift of the tip of the recording medium, it is difficult to accurately detect a boundary between the transparent part and the non-transparent part when the recording medium disclosed in Japanese Patent Application Laid-Open No. 2005-10529 is used.

Moreover, in Japanese Patent Application Laid-Open No. 2002-341623, a special toner for a gloss is used. After normal image formation is performed on a sheet and before the sheet goes to the fixing unit, transparent toner is evenly formed on the entire surface and is fixed, thereby obtaining a high gloss characteristic. However, this technology has problems, such that transparent toner is always evenly supplied to the entire surface and the load on the fixing unit is high due to a difference in toner thickness between an image portion and a non-image portion.

In Japanese Patent Application Laid-Open No. 2004-191678, a special recording medium is used for a gloss. A thermoplastic resin layer is provided on the front and back sides of a sheet and, after an image is normally fixed, pressure and heat are further added, thereby achieving an even gloss on the surface. However, this technology can achieve effects with the special fixing device disclosed in Japanese Patent Application Laid-Open No. 2004-191678, and therefore has problems in configuration, cost, power consumption, and other points.

The conventional technology in Japanese Patent Application Laid-Open No. 2003-270991 discloses that, after normal fixing (first fixing), a second fixing unit formed of a high-smooth belt is provided to again melt the toner, and then cooling and exfoliation are performed, and by using the smoothness of the belt, an even gloss can be obtained. As with Japanese Patent Application Laid-Open No. 2004-191678, there are problems in configuration, cost, power consumption, and other points.

Japanese Patent Application Laid-Open No. 2001-305894 discloses a technology based on the premise that an optical retroreflection sheet, which is difficult to print, is used. Since it is difficult to print on an optical retroreflection sheet, an object of this invention is to process with the use of a transparent film, but not to seek photographic image quality.

The present invention has been devised in view of the above, and an object of the present invention is to automatically reverse an original image on a transparent recording medium to form an image.

An object of the present invention is to provide a paper feeding apparatus' and image forming apparatus capable of accurately detecting a boundary between a transparent part and a non-transparent part on a recording medium.

The present invention provides an image recording medium, image recording medium manufacturing method, and image forming apparatus with a simple configuration and excellent keeping quality and capable of obtaining a glossy image with a photographic tone.

### DISCLOSURE OF INVENTION

An image forming apparatus according to one aspect of the present invention includes a conveyor path through which a recording medium is conveyed, which includes a non-transparent recording medium and a transparent recording medium at least a part of which is transparent; an image forming unit that forms an image on the recording medium; a recording-medium selecting unit that selects either the non-transparent recording medium or the transparent recording medium, and conveys selected recording medium to the conveyor path; an image selecting unit that selects an image to be formed on the recording medium from an original image and a reversed image obtained by reversing the original image; and a control unit that controls, based on a first control signal, the recording-medium selecting unit to select the transparent recording medium and the image selecting unit to select the reversed image, to form the reversed image on the transparent recording medium, and controls, based on a second control signal, the recording-medium selecting unit to select the transparent recording medium an the image selecting unit to select no image.

According to the present invention, based on the single control signal, selection of the type of the recording medium and reversal of the original image are performed. Therefore, an image obtained by reversing the original image can be automatically formed on the transparent recording medium. With this, in post-processes, the non-transparent recording medium is superposed on the surface of the transparent recording medium having formed thereon the image obtained by reversing the original image, thereby obtaining an image with photographic image quality.

An image forming system according to another aspect of the present invention includes an image forming apparatus according to the present invention; and an external apparatus that communicates with the image forming apparatus. The external apparatus transmits the first control signal to the image forming apparatus.

According to the present invention, based on the single control signal from the outside, selection of the type of the recording medium and reversal of the original image are performed. Therefore, an image obtained by reversing the original image can be automatically formed on the transparent recording medium. With this, in post-processes, the non-transparent recording medium is superposed on the surface of the transparent recording medium having formed thereon the image obtained by reversing the original image, thereby obtaining an image with photographic image quality.

A paper feeding apparatus according to still another aspect of the present invention includes a pair of resist rollers for conveying a recording medium having a transparent part and a non-transparent part, and aligns the recording medium at a predetermined timing; and a boundary detection sensor that detects a boundary between the transparent part and the non-transparent part. The boundary detection sensor is provided at a downstream position in a direction in which the resist rollers convey the recording medium.

According to the present invention, the boundary detection sensor is provided at a position on a downstream side in a direction in which the resist rollers convey the recording medium. Therefore, the boundary portion between the transparent part and the non-transparent part can be accurately detected almost without a difference in slack or an error in the amount of nipping or the like.

An image forming apparatus according to still another aspect of the present invention includes a paper feeding apparatus that includes a pair of resist rollers for conveying a recording medium having a transparent part and a non-transparent part, and aligns the recording medium at a predetermined timing, and a boundary detection sensor that detects a boundary between the transparent part and the non-transparent part; and an image forming unit that forms an image on the recording medium. The boundary detection sensor is provided at a downstream position in a direction in which the resist rollers convey the recording medium. The recording medium is folded along the boundary between the transparent part and the non-transparent part so that the transparent part and the non-transparent part are superposed each other.

According to the present invention, since the recording medium can be folded along the boundary portion between the transparent part and the non-transparent part to superpose the transparent part and the non-transparent part, a paper feeding operation is easier compared with the case of the transparent recording medium and the non-transparent recording medium separately fed, and a configuration required for superposing the transparent recording medium and the non-transparent recording medium is not necessary.

An image recording medium according to still another aspect of the present invention includes a recording medium that is a sheet-like medium on which an image is formed by an image forming apparatus, where at least a part of the recording medium is transparent; a superposing medium that is superposed on a transparent part of the recording medium; and an adhesive layer on which an adhesive is applied. The superposing medium is bonded onto an image forming surface of the transparent part via the adhesive layer.

According to the present invention, since the transparent part and the non-transparent part (superposing medium) are integrally formed via an adhesive layer and the recording image is covered with the transparent part, excellent keeping quality can be achieved. Also, since the surface of the transparent part is glossy, the image can be seen as a photographic-tone image with a gloss.

A method according to still another aspect of the present invention is for creating an image recording medium using a recording medium that is a sheet-like medium on which an image is formed by an image forming apparatus, where at least a part of the recording medium is transparent. The method includes forming an image on a transparent part of the recording medium; and bonding a sheet-like superposing medium onto an image forming surface of the transparent part via an adhesive.

According to the present invention, since the transparent part and the non-transparent part (superposing medium) are integrally formed via an adhesive layer and the recording image is covered with the transparent part, excellent keeping quality can be achieved. Also, since the surface of the transparent part is glossy, the image can be seen as a photographic-tone image with a gloss.

### BRIEF DESCRIPTION OF DRAWINGS

FIG. 1 is an explanatory drawing that depicts a configuration example of an image forming apparatus according an embodiment of the present invention;

FIG. 2 is an explanatory drawing that depicts one example of an operating unit of the image forming apparatus;

FIG. 3 is a flowchart of an operation (1) according to the embodiment of the present invention;

FIG. 4 is a drawing that depicts a state of a section after folding a non-transparent medium;

FIG. 5 is a drawing that depicts steps of forming a photographic-tone image by superposing transparent and non-transparent media;

FIG. 6 is a flowchart of an operation (2) according to the embodiment of the present invention;

FIG. 7 is a plan view of a recording medium formed of a transparent part and a non-transparent part;

FIG. 8 is a perspective view that depicts a state of conveying a recording medium by resist rollers;

FIG. 9 is a section view that depicts a state of conveying a recording medium by the resist rollers;

FIG. 10 is a drawing that depicts a state in which the transparent part of the recording medium is conveyed to the resist rollers and is detected by a boundary detection sensor;

FIG. 11 is a drawing that depicts a state in which the non-transparent part of the recording medium is conveyed to the resist rollers and is detected by the boundary detection sensor;

FIG. 12 is a drawing for explaining an image forming operation on the recording medium, in which (a) is a plan view that depicts a state in which a horizontally-reversed image is formed on the transparent part of the recording medium, and (b) is a perspective view of the transparent part and the non-transparent part being superposed each other;

FIG. 13 is a drawing for explaining an image forming operation on the recording medium, in which (a) is a plan view that depicts a state in which a vertically-reversed image is formed on the transparent part of the recording medium, and (b) is a perspective view of the transparent part and the non-transparent part being superposed each other;

FIG. 14 is a drawing for explaining an image forming operation on the recording medium, in which (a) is a drawing when the area of the transparent part is equal to or smaller than a half of the entire area of the recording medium, and (b) is a drawing when the area of the transparent part is equal to or larger than a half of the entire area of the recording medium;

FIG. 15 is a drawing for explaining an image forming operation on the recording medium, in which (a) is a drawing that depicts a recording medium having a hollow image of the original image formed on the non-transparent part and (b) is a drawing of the transparent part and the non-transparent part being superposed each other;

FIG. 16 is a drawing for explaining an image forming operation on the recording medium and is a drawing for explaining a recording medium in which the non-transparent part is provided at a position surrounding the transparent part;

FIG. 17 is a drawing for explaining an image forming operation on the recording medium and is a drawing for explaining a recording medium having an image formed on the non-transparent part;

FIG. 18 is a drawing that depicts main portions of the image forming apparatus when a reflective photosensor is used as a boundary detection sensor;

FIG. 19 is a schematic flow diagram of a flow of manufacturing an image recording medium with a glossy image;

FIG. 20 is a drawing for explaining a state in the course of manufacturing an image recording medium with a glossy image;

FIG. 21 is a section view of the image recording medium with a glossy image;

FIG. 22 is a drawing that depicts, step by step, a process of folding the transparent part when a folding portion has formed thereon a concave portion;

FIG. 23 is a drawing that exemplarily depicts various recording media with different ratios of transparent part occupying the entire recording medium; and

FIG. 24 is a flowchart for explaining an image forming process at a control unit provided incidentally to the image forming apparatus.

### BEST MODE(S) FOR CARRYING OUT THE INVENTION

Exemplary embodiments of the present invention will be explained in detail below with reference to the accompanying drawings.

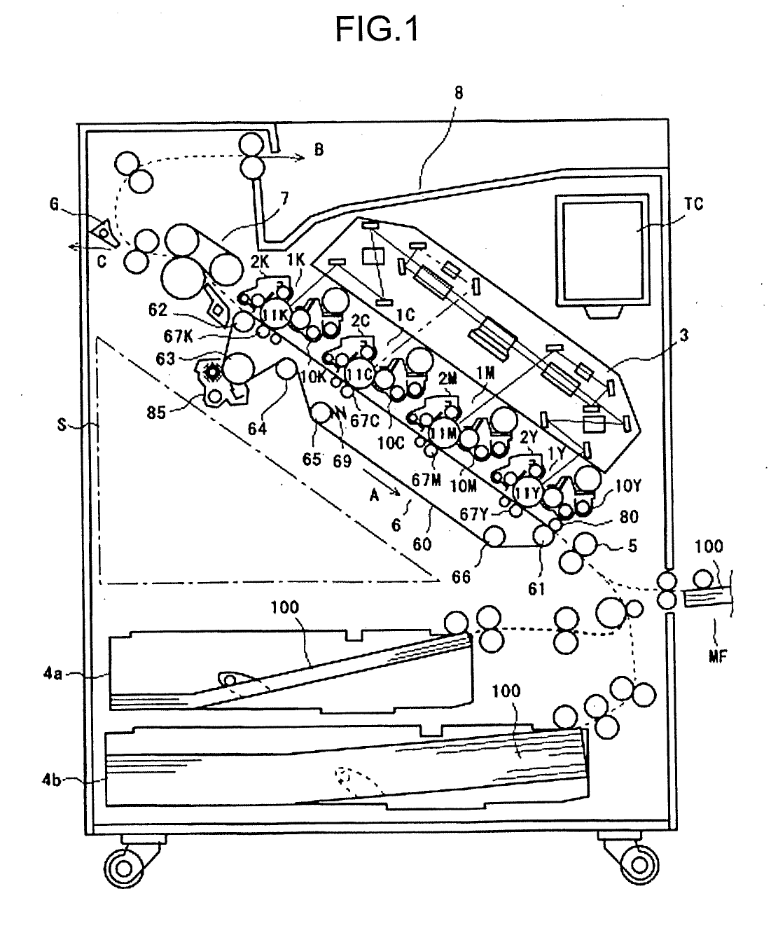

FIG. 1 is an explanatory drawing that depicts a configuration example of an image forming apparatus according to a first embodiment of the present invention. The image forming apparatus includes four image forming units 1Y, 1M, 1C, and 1K for forming images of colors of yellow (Y), magenta (M), cyan (C), and black (K). Here, the color order of Y, M, C, and K is not restricted to the order of FIG. 1, and may be other orders.

The image forming units 1Y, 1M, 1C, and 1K include photosensitive drums 11Y, 11M, 11C, and 11K as image carriers, respectively, a charging unit, a developing unit, and a cleaning unit. Also, the arrangement of the image forming units 1Y, 1M, 1C, and 1K is set so that rotational axes of the photosensitive drums are parallel to one another and are arranged with a predetermined pitch in a transfer sheet moving direction.

The image forming units 1Y, 1M, 1C, and 1K has arranged thereabove an optical writing unit 3 that includes a light source, a polygon mirror, an f-θ lens, a reflective mirror, and others and, based on image data, irradiates the surface of each of the photosensitive drums 11Y, 11M, 11C, and 11K while scanning with laser light, and has arranged therebelow a transferring unit 6, as a belt driving device, that has a transfer conveyor belt 60 that carries a transfer sheet for conveyance so as to pass through a transfer unit of each image forming unit. On a perimeter surface of the transfer conveyor belt 60, a cleaning device 85 including a brush roller and a cleaning blade is arranged so as to be in contact with the perimeter surface. With the cleaning device 85, foreign substances, such as toner, attached on the transfer conveyor belt 60 are removed.

On a side of the transferring unit 6, a fixing unit 7 of a belt fixing scheme, a paper delivery tray 8, and others are provided. Under the image forming apparatus, paper feeding cassettes 4a and 4b each with transfer sheets 100 mounted thereon are provided. Also, a manual paper feeding tray MF is provided for manually feeding sheets from a side surface of the image forming apparatus.

In addition, a toner supply container 21C is provided, and a waste toner bottle, a single-side/duplex unit, a power supply unit, and others that are not shown are provided in a space S indicated by a two-dot-chain line.

Developing devices 10Y, 10M, 10C and 10K as developing units are configured similarly. These are the developing devices 10Y, 10M, 10C and 10K of a two-component developing scheme only different in color of the toner for use, and each have accommodated therein a developer formed of toner and a magnetic carrier.

The developing devices 10Y, 10M, 10C and 10K each include a developing roller facing the photosensitive drum 11, a screw that conveys and agitates a developer, a toner density sensor, and others. The developing roller includes an external rotatable sleeve and an inner fixed magnet. According to an output from the toner density sensor, toner is supplied from a toner supply device.

A predetermined voltage is applied from a power supply not shown to a charging roller 14a, thereby charging the facing surface of the photosensitive drum 11. The surface of the photosensitive drum 11 charged at a predetermined potential is then scanned by the optical writing unit 3 with laser light based on the image data, thereby writing an electrostatic latent image. When the surface of the photosensitive drum 11 having carried thereon the electrostatic latent image reaches the developing device 10, toner is supplied to the electrostatic latent image on the surface of the photosensitive drum 11 from the developing roller arranged so as to face the photosensitive drum 11 to form a toner image.

The operation is similarly performed for all of photosensitive units 2Y, 2M, 2C, and 2K at a predetermined timing. On the surface of each of the photosensitive drums 11Y, 11M, 11C, and 11K, a-toner image of each predetermined color is formed.

The transfer sheet 100 is conveyed either of the paper feeding cassettes 4a and 4b and the manual paper feeding tray MF, and once stops upon reaching resist rollers 5. Then, at the timing of the image forming operation of the photosensitive units 2Y, 2M, 2C, and 2K, the transfer sheet 100 is fed by the resist rollers 5, and has sequentially transferred thereon the toner images on the respective photosensitive drums 11 while being conveyed by the transfer conveyor belt 60. This transfer of the toner images onto the transfer sheet is performed from primary transfer rollers 67Y, 67M, 67C, and 67K arranged so as to face the photosensitive drums 11Y, 11M, 11C, and 11K across the transfer conveyer belt 60, by applying a voltage from the power supply not shown with a polarity in reverse to the polarity of the toner on each photosensitive drum 11.

The transfer sheet 100 passing through a position facing to the photosensitive drum 11K and having superposed thereon toner images of four colors is then conveyed to the fixing unit 7, where an image is fixed by receiving heat and pressure.

The image forming apparatus for use according to the first embodiment is not particularly characterized by this configuration. For example, the configuration may be such that LED may be used in place of a laser as a writing scheme. As a developing unit, a one-component one in place of a two-component one may be used. As a fixing unit, a roller or induction heating scheme may be used in place of a belt.

In the configuration shown in FIG. 1, it is defined that, for example, the paper feeding cassette 4a (or the paper feeding cassette 4b, depending on the configuration) has transparent recording media set therein. On the other hand, it is defined that the paper feeding cassette 4b has non-transparent media set therein (when it is defined that the transparent recording media are set in the paper feeding cassette 4b, it is defined that the non-transparent media are set in the paper feeding cassette 4a).

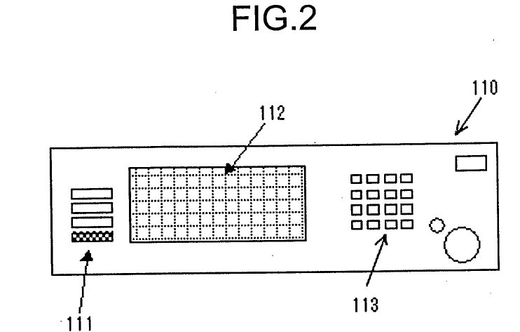

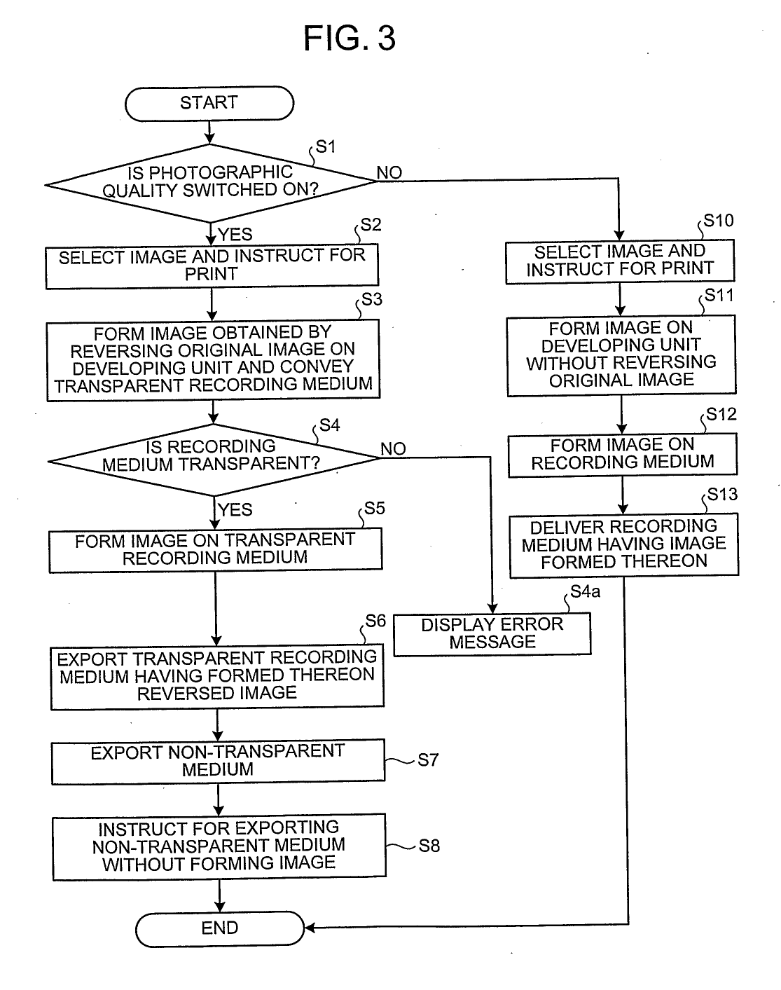

Explanation is made below according to a flowchart shown in FIG. 3. First, with an operation unit that causes a single control signal to occur, when the user outputs photographic image quality, on a control panel of an operating unit 110 as shown in FIG. 2, the user presses a photographic image quality switch 111 (step S1). In FIG. 2, a reference numeral 112 denotes a display, and a reference numeral 113 denotes an operation button group.

Then, image selection by the user and other operations are preformed (step S2). Upon an input of an input signal indicative of an instruction for print from the user, based on a single first control signal, a recording-medium selecting unit is caused to select a transparent recording medium. By causing an image selecting unit to select an image obtained by reversing an original image, the image obtained by reversing the original image is formed on the transparent recording medium. Based on a second control signal, without causing the image selecting unit to select an image, by using a function of causing the recording-medium selecting unit to select a transparent recording medium, the machine body generates image data obtained by (horizontally or vertically) reversing a user-input image (a scanned image, as for copying) through digital processing. Formation of this image obtained by reversing the original image is started on an image carrier at the developing unit (step S3).

One or more paper feeding trays that independently stock non-transparent recording media and transparent media are further provided. With a function of causing a selected recording medium in a relevant one of paper feeding trays to be conveyed to a conveyer path according to selection of either one of the non-transparent recording medium and the transparent recording medium, the transparent recording medium is started to be conveyed from the paper feeding cassette 4a at an appropriate timing (step S4). Here, the function explained above means that paper feeding is made not from the paper feeding cassette 4b having the non-transparent media set therein but a transparent recording medium is fed from the paper feeding cassette 4a having the transparent recording media set therein. Here, if the fed recording medium is not transparent, an error message is displayed (step S4a).

At this time, when it is detected whether the recording medium is non-transparent or transparent and the selected recording medium matches with the detected recording medium, with a function of conveying the recording medium through a conveying path, the optical sensor detects whether the recording medium conveyed from the paper feeding cassette 4a is a transparent recording medium having appropriate transparency. At this detection, if it is determined that it is not a recording medium with appropriate transparency, an error message is displayed. On the other hand, if it is determined that it is a transparent recording medium with appropriate transparency, the procedure goes to following processes.

Based on a single control signal, before or after causing the recording-medium selecting unit to select the transparent recording medium, the recording-medium selecting unit is caused to select a non-transparent white recording medium. With this, before or after causing the transparent recording medium having an image obtained by reversing an original image to be conveyed through the conveying path, with a function of causing the non-transparent white recording medium to be conveyed through the conveying path, a reversed image is formed on the transparent recording medium (step S5). During conveyance before or after a post-process, such as a fixing process, conveyance of a non-transparent recording medium 120 set in the paper feeding cassette 4b is started (steps S6 and S7).

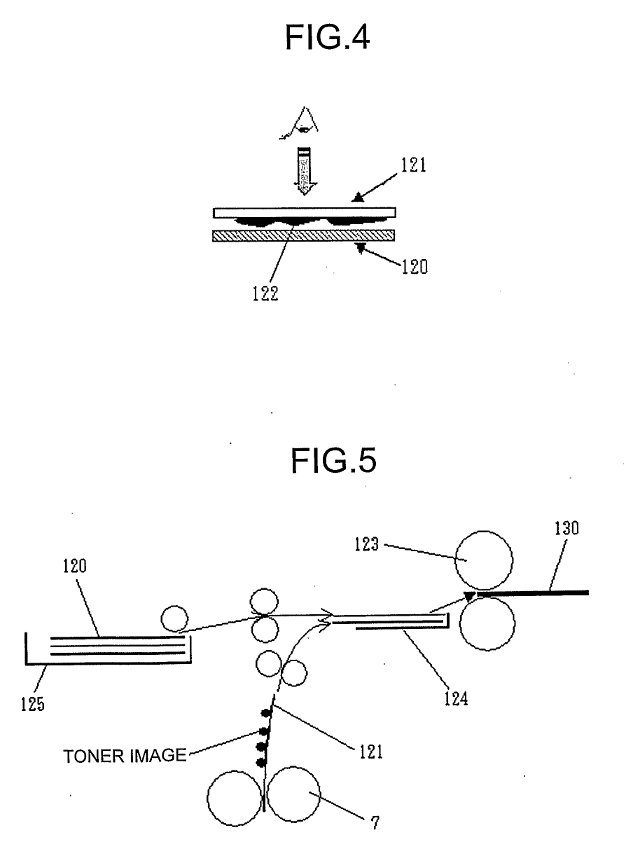

An object of the non-transparent recording medium 120 is, as shown in FIG. 4 depicting the state of a section after folding, to be arranged so as to interpose the reversed toner image with respect to a transparent recording medium 121, and function as a reflecting plate from the back with respect to a reversed toner image 122 (on a side of the transparent recording medium 121). Therefore, for example, a white sheet, which has a high reflectance across the entire visible light, is preferable in view of image quality. However, this is not meant to be restrictive as long as it is a non-transparent medium. Also, the non-transparent medium does not have to have an image formed thereon, but can allow image formation thereon.

Next, a delivering unit that delivers the recording medium conveyed through the conveyor path to outside of the apparatus is provided. With this delivering unit, before or after delivering the transparent recording medium having formed thereon the image obtained by reversing the original image to the outside of the apparatus, with a function of delivering the non-transparent white recording medium to the outside of the apparatus, before or after the transparent recording medium having formed thereon the reversed image is delivered, the non-transparent medium is delivered downward or upward (step S8). Regarding this, when a toner image of the transparent recording medium having formed thereon the reversed image is formed on a lower surface, the non-transparent medium is delivered before the transparent recording medium is delivered. At this time, as shown in FIG. 4, the transparent recording medium and the non-transparent medium are superposed each other in a state such that a toner image formed on the transparent recording medium is interposed therebetween. At this time, depending on the configuration of the transparent recording medium and the non-transparent medium may be superposed each other in either vertical order.

That is, photographic image quality is obtained with the both media being superposed each other. However, being merely superposed, both are peeled off due to disturbance, such as a touch by the user. To get around this, a bonding unit that bonds a pair of recording media is provided. Also, with a function of the bonding unit bonding the non-transparent white recording medium on the surface of the transparent recording medium on which the image obtained by reversing the original image, as in the example shown in FIG. 5, after both media are superposed, a bumping member for alignment or the like is used for alignment of both. Then, with a member, such as a roller, a process of bonding both is performed.

In the apparatus according to the present invention, since the toner image is bonded to the transparent medium side, an extremely high-quality image can be obtained compared with a laminator with which a document is simply interposed by a transparent medium. Also, since the configuration is such that the toner image is interposed between the transparent medium and the non-transparent medium, keeping quality is extremely good.

If the photographic image quality switch 111 is turned off at step S1, image selection and instruction for print are preformed (step S10), an image is formed on the developing unit without reversing the original image to form an image on the developing unit (step S11), an image is formed on the recording medium (step S12), and then the recording medium having the image formed thereon is delivered (step S13).

Meanwhile, an example shown in FIG. 5 depicts that, one of the surfaces of the non-transparent recording medium 120 that is on a side in contact with the transparent recording medium 121 has applied thereto a material that takes effects of adhesiveness by heating, and the transparent recording medium 121 and the non-transparent recording medium 120 are bonded together by passing through rollers 123 including a heating unit. In the drawing, a reference numeral 124 denotes a bumping member for alignment, a reference numeral 125 denotes a non-transparent member tray, and a reference numeral 130 denotes a medium having formed thereon a photographic-tone image.

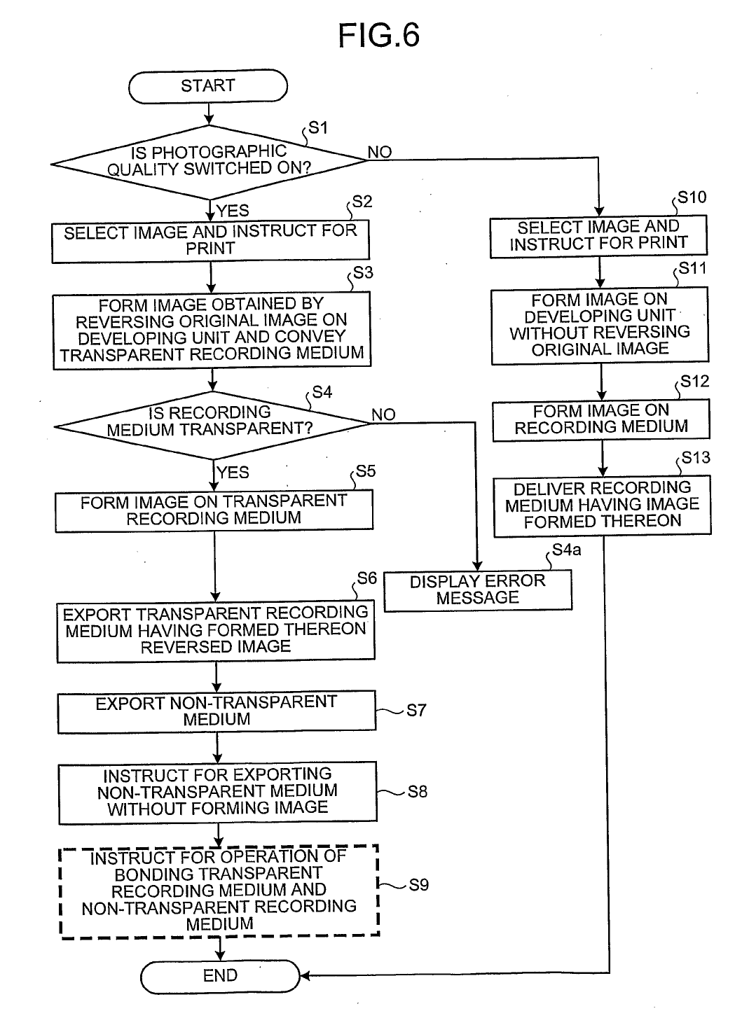

This process takes a form in a flowchart of FIG. 6 such that this process is inserted as “instruct for an operation of bonding the transparent recording medium and the non-transparent recording medium” (step S9) after step S8 of the flowchart of FIG. 3. In such a configuration as shown in FIG. 4 according to the present invention, if a member having a smooth surface is selected as the transparent recording medium, photographic image quality with its image surface being extremely smooth and with a gloss can be obtained.

Bonding the non-transparent recording medium 120 and the transparent recording medium 121 may be performed after image formation on the non-transparent recording medium 120 is completed or before image formation on the non-transparent recording medium 120 is completed.

That is, in the case of image formation through electrophotographic process, the transparent recording medium 121 may be bonded onto the non-transparent recording medium 120 after the image is transferred and fixed to the non-transparent recording medium 120. Alternatively, the image may be fixed to the non-transparent recording medium 120 after the image is transferred to the non-transparent recording medium 120 and simultaneously with the time when the transparent recording medium 121 is bonded to the non-transparent recording medium 120.

As described above, these selections when photographic image quality is output can be performed through operations at the operating unit as shown in FIG. 2.

Also, this operating unit can be achieved not only by being placed in the apparatus body, but can also be achieved through transmission of a control signal from an external device, such as a personal computer. In other words, an image forming system can be configured that includes an image forming apparatus and a communicative external device, in which the external device can transmit the single control signal to the image forming apparatus.

That is, according to the first invention, based on the single control signal, selection of the type of the recording medium and reversal of the original image are performed. Therefore, an image obtained by reversing the original image can be automatically formed on the transparent recording medium. With this, in post-processes, the non-transparent recording medium is superposed on the surface of the transparent recording medium having formed thereon the image obtained by reversing the original image, thereby obtaining an image with photographic image quality.

A paper feeding cassette having transparent recording media set therein is provided, and a control mechanism is provided in which an appropriate paper feeding cassette is selected from a plurality of paper feeding cassettes. Therefore, according to the selection of either of the transparent recording medium and the non-transparent recording medium, the transparent recording medium can be automatically conveyed.

Furthermore, a mechanism that detects transparency in the conveyed recording medium by using an optical sensor is provided. Therefore, it is detected whether the conveyed recording medium is transparent, and the image obtained by reversing the original image can be reliably formed on the transparent recording medium (it is possible to support even a case such that a wrong recording medium has been set in a manual paper feeding tray or a paper feeding tray).

Since the transparent recording medium having formed thereon the image obtained by reversing the original image and the non-transparent white recording medium are conveyed as a set, it is easy to superpose both in a post-process.

The transparent recording medium having formed thereon the image obtained by reversing the original image and the non-transparent white recording medium can be automatically bonded together. With the same signal, conveyance of the transparent recording medium and an instruction for reversing the original image can be made by using a component set as a switch on the operating unit of the main body. Therefore, with the operation of the operating unit, the image obtained by reversing the original image can be formed on the transparent recording medium.

Still further, a controlling device, such as a personal computer, is present as an external device. Therefore, the image obtained by reversing the original image can be formed on the transparent recording medium through transmission of a control signal from the external device.

The configuration and operation of an image forming apparatus according to a second embodiment of the present invention are similar to those in FIG. 1, and therefore are not redundantly explained herein.

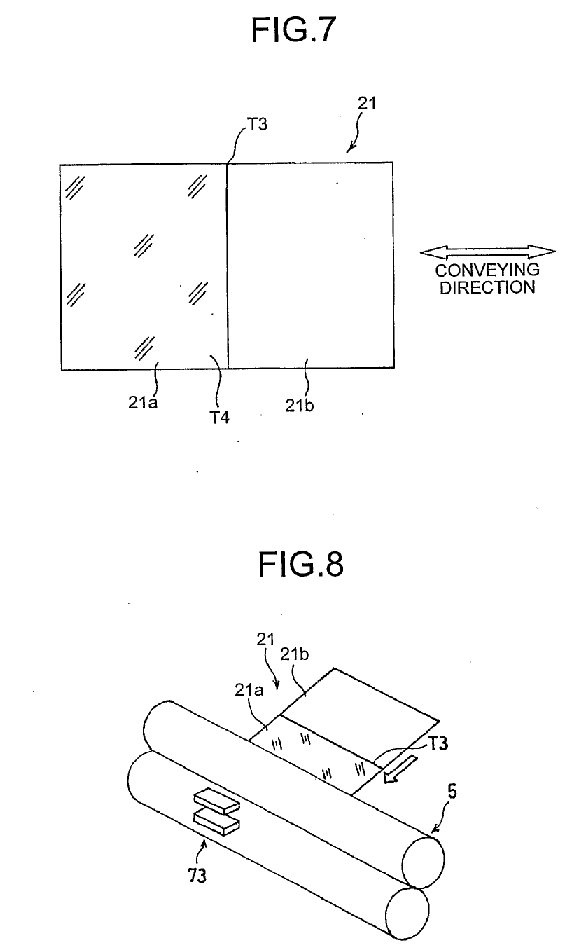

As shown in FIG. 7, a recording medium 21 has a transparent part 21a on one side and a non-transparent part 21b on the other side. At an approximately center position in a direction of conveying the recording medium 21 is a boundary portion T3 between the transparent part 21a and the non-transparent part 21b. Also, the non-transparent part 21b is white. The transparent part 21a has a surface T4 on which an image is formed, and this surface T4 is a smooth surface so as to obtain a photographic-tone image 9 with a gloss. Also, if a back surface T5 of the transparent part 21a on which no image is formed is a smooth surface, photographic-tone image quality with a more gloss can be obtained.

In the image forming apparatus according to the second embodiment, as shown in FIGS. 8 to 11, a resist sensor 74 is provided at an upstream position in a direction in which the resist rollers 5 convey the recording medium. Upon reception of a detection signal from the resist sensor 74, the resist rollers 5 waits in a state where the recording medium 21 bumps at a nip portion 5a of the resist rollers 5. At a downstream position in the direction in which the resist rollers 5 convey the recording medium 21, a boundary detection sensor 73 that detects a boundary between the transparent part 21a and the non-transparent part 21b of the recording medium 21 is provided.

The boundary detection sensor 73 is a transmission-type photosensor, and is provided with a light emitting unit 73a that emits light toward a conveying surface of the recording medium 21 and a light receiving unit 73b that is provided at a position facing the light emitting unit 73a and detects the light from the light emitting unit 73a. In the boundary detection sensor 73, when the non-transparent part 21b of the recording medium 21 is positioned between the light emitting unit 73a and the light receiving unit 73b, the non-transparent part 21b is shielded from light. On the other hand, when the transparent part 21a of the recording medium 21 is positioned between the light emitting unit 73a and the light receiving unit 73b, the light receiving unit 73b receives the light from the light emitting unit 73a, and transmits a light-receiving signal to a control unit. Upon detecting the light receiving signal, the control unit detects the boundary portion T3 between the transparent part 21a and the non-transparent part 21b of the recording medium 21.

The developing devices 10Y, 10M, 10C and 10K are of a two-component developing scheme and are different only in toner color for use, and each have accommodated therein a developer formed of toner and a magnetic carrier. The developing devices 10Y, 10M, 10C and 10K each include a developing roller facing the photosensitive drum 11, a screw that conveys and agitates a developer, a toner density sensor, and others. The developing roller includes an external rotatable sleeve and an inner fixed magnet. According to an output from the toner density sensor, toner is supplied from a toner supply device.

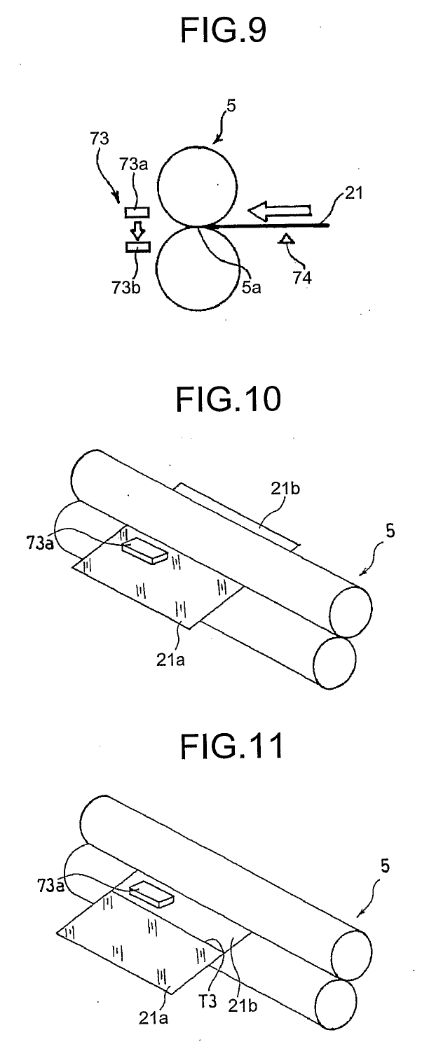

The recording medium 21 is conveyed either of the paper feeding cassettes 4a and 4b and the manual feeding tray MF, and once stops upon reaching the nip portion 5a of the resist rollers 5 (see FIGS. 8 and 9). Then, at the timing of the image forming operation of the photosensitive units 2Y, 2M, 2C, and 2K, the recording medium 21 is fed by the resist rollers 5. In the recording medium 21 fed by the resist rollers 5, the boundary portion T3 between the transparent part 21a and the non-transparent part 21b of the recording medium 21 is detected by the boundary detection sensor 73.

That is, when the transparent part 21a of the recording medium 21 is positioned between the light emitting unit 73a and the light receiving unit 73b, the light from the light emitting unit 73a is received at the light receiving unit 73b (see FIG. 10). When the recording medium 21 is further conveyed to a downstream in a conveying direction and the non-transparent part 21b is positioned between the light emitting unit 73a and the light receiving unit 73b, the non-transparent part 21b shields the light from the light emitting unit 73a (see FIG. 11).

The light receiving signal at the light receiving unit 73b is detected by the control unit to detect the boundary portion T3 between the transparent part 21a and the non-transparent part 21b of the recording medium 21. Then, by taking a signal received at the light receiving unit 73b as a trigger, an image forming operation is performed.

While the recording medium 21 passing through the resist rollers 5 is being conveyed by the transfer conveyor belt 60, the toner images of the respective photosensitive drums 11 are sequentially transferred thereon. This transfer of the toner images onto the recording medium 21 is performed from the primary transfer rollers 67Y, 67M, 67C, and 67K arranged so as to face the photosensitive drums 11Y, 11M, 11C, and 11K across the transfer conveyer belt 60, by applying a voltage from the power supply with a polarity in reverse to the polarity of the toner on each photosensitive drum 11.

Then, the recording medium 21 passing through a position facing to the photosensitive drum 11K and having superposed thereon toner images of four colors is then conveyed to the fixing unit 7, where an image 9 is fixed by receiving heat and pressure.

According to the second embodiment, the boundary detection sensor 73 is provided at a position on a downstream side in a direction in which the resist rollers 5 convey the recording medium 21. Therefore, the boundary portion T3 between the transparent part 21a and the non-transparent part 21b can be accurately detected almost without a difference in slack or an error in the amount of nipping or the like. Therefore, by using an ON/OFF signal received at the light receiving unit 73b as a writing trigger of the image forming unit, the image 9 can be formed with high accuracy at a target position of the transparent part 21a in the recording medium 21.

Since the non-transparent part 21b of the recording medium 21 is white, when the recording medium 21 is folded along the boundary to superpose the transparent part 21a and the non-transparent part 21b each other, the image 9 excellent in reproducibility of color tones can be obtained.

Next, another embodiment is explained. In the following explanation, portions that achieve operation effects identical to these in the embodiments are provided with the same reference numerals, and are not explained in detail. In the following explanation, points that are different from those in the -th embodiment explained above are mainly

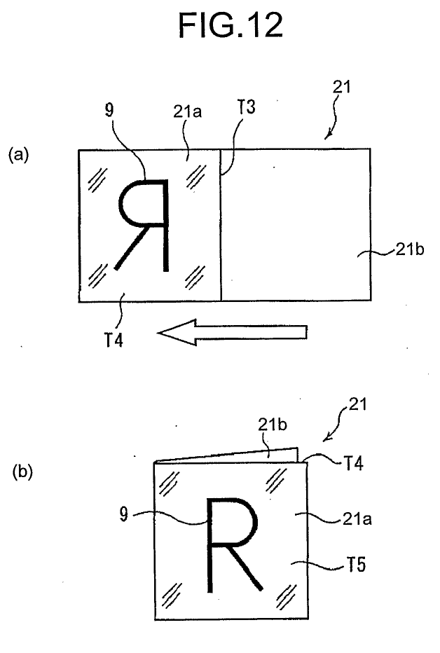

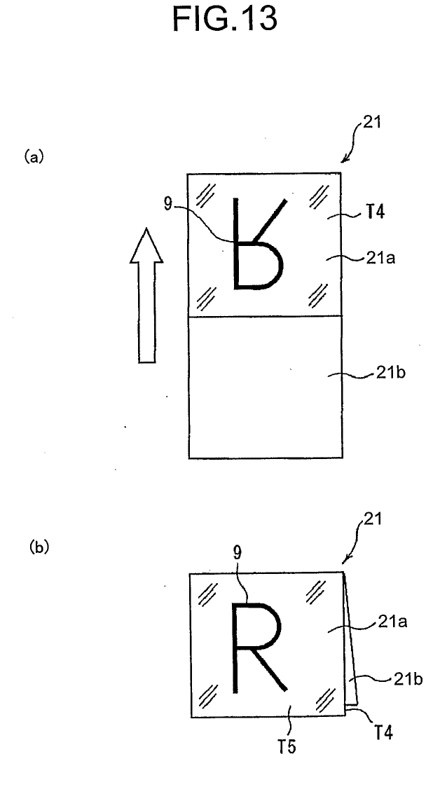

According to the present embodiment, the image 9 is formed by horizontally or vertically reversing the original image on the surface T4 of the transparent part 21a of the recording medium 21. When such a reversed image is formed, image data read by a reading device is subjected to a reversing process at the control unit. Then, with the image data after the reversing process, an electrostatic latent image is written by the optical writing unit 3 on a photosensitive member, and the reversed image is transferred to the recording medium 21, thereby forming an image on the transparent part 21a (see FIG. 12(a) and FIG. 13(a)).

In this manner, with the original image being horizontally or vertically reversed on the surface T4 of the transparent part 21a of the recording medium 21 to form the image 9, when the recording medium 21 is folded along the boundary portion T3 portion to superpose the transparent part 21a and the non-transparent part 21b, when viewed from the non-image surface (back surface) T5 of the recording medium 21, a normal non-reversed image can be obtained.

A process of folding the recording medium 21 can be performed by a folding processing unit of a post-processing device provided adjacent to the image forming apparatus.

Since the recording medium 21 can be folded along the boundary portion T3 between the transparent part 21a and the non-transparent part 21b to superpose the transparent part 21a and the non-transparent part 21b, a paper feeding operation is easier compared with the case of the transparent recording medium and the non-transparent recording medium separately fed, and a configuration required for superposing the transparent recording medium and the non-transparent recording medium is not necessary.

The transparent part 21a and the non-transparent part 21b are not only simply folded to be superposed, but also the transparent part 21a and the non-transparent part 21b may be bonded after superposing the transparent part 21a and the non-transparent part 21b by folding. In this case, since the image forming surface is covered with the transparent part 21a, the image forming surface are not directly exposed to the outside, thereby keeping the image with good quality.

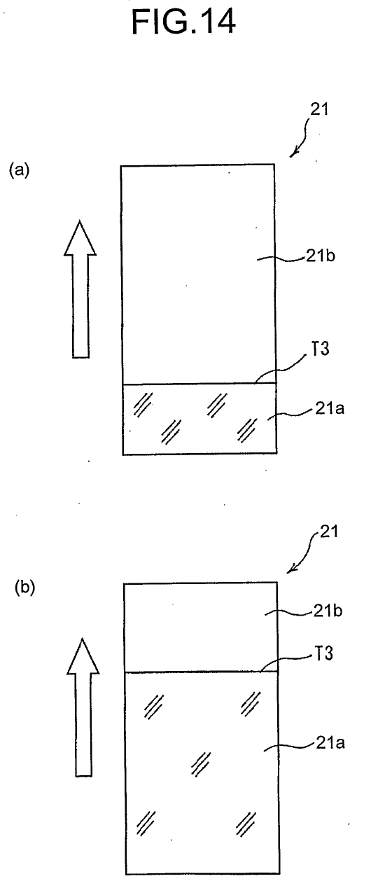

Next, still another embodiment is explained by using FIG. 14. According to the present embodiment, the area of the transparent part 21a of the recording medium 21 is equal to or smaller than a half of the entire area of the recording medium. In an example shown in FIG. 14(b), the area of the transparent part 21a of the recording medium 21 is equal to or larger than the half of the entire area of the recording medium. Here, in this case, to allow the boundary portion T3 between the transparent part 21a and the non-transparent part 21b by the boundary detection sensor 73, the boundary portion T3 between the transparent part 21a and the non-transparent part 21b is formed in a direction orthogonal to the direction of conveying the recording medium 21. According to the present embodiment, the area of the transparent part 21a of the recording medium 21 can be arbitrarily changed, thereby achieving excellent usability.

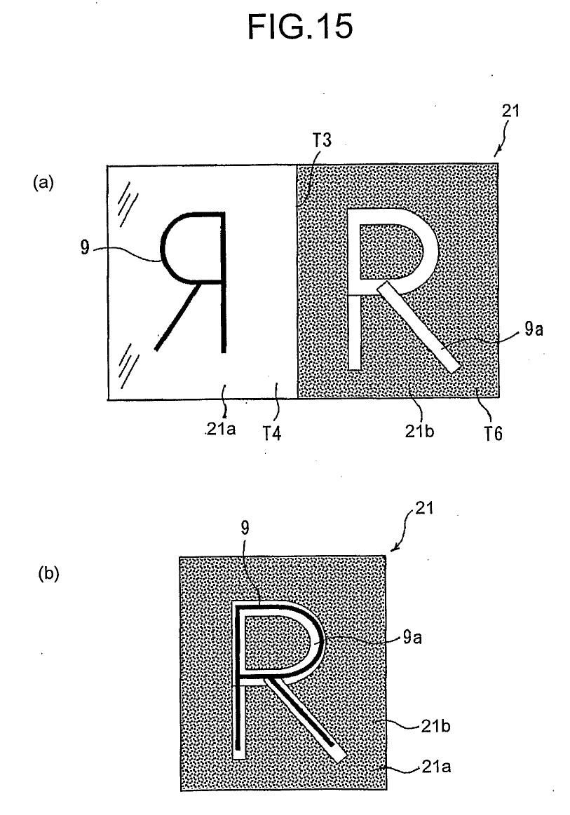

Next, still another embodiment is explained by using FIG. 15. According to the present embodiment, the reversed image 9 is formed on the transparent part 21a of the recording medium 21, and also a hollow image 9a of the original image is formed on the non-transparent part 21b. According to the present embodiment, when the transparent part 21a and the non-transparent part 21b are superposed by folding, the image 9 and the hollow image 9a are superposed each other to enhance a decorative effect.

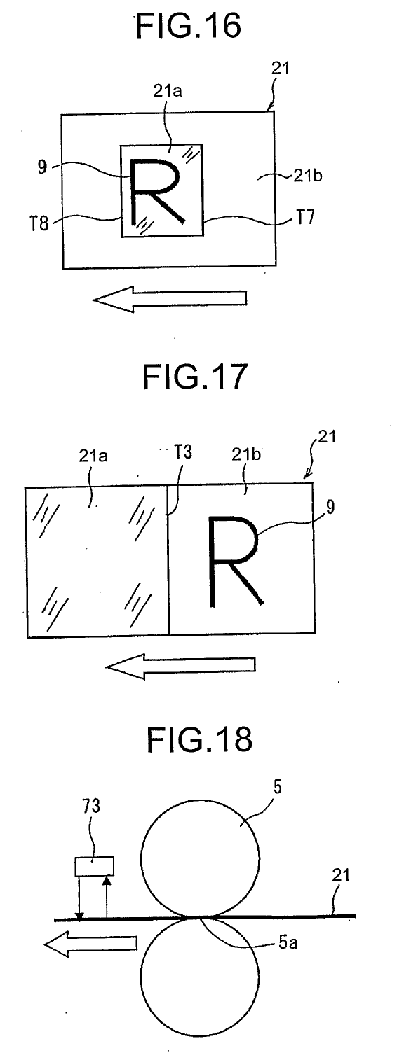

Next, still another embodiment is explained by using FIG. 16. According to the present embodiment, the non-transparent part 21b is provided at a position surrounding the transparent part 21a where the image 9 is formed. Then, a front end T8 of the transparent part 21a in the direction of conveying the recording medium and a rear end T7 thereof in the conveying direction are detected by the boundary detection sensor 73. In this manner, even when the transparent part 21a is provided at an arbitrary position inside of the recording medium 21, the front end T8 of the transparent part 21a in the direction of conveying the recording medium and the rear end T7 thereof in the conveying direction are detected by the boundary detection sensor 73, thereby forming the image 9 at a target position on the transparent part 21a.

Next, still another embodiment is explained by using FIG. 17. According to the present embodiment, the image 9 is formed on the non-transparent part 21b of the recording medium 21. In this manner, even when the image 9 is formed on the non-transparent part 21b, the boundary portion T3 between the transparent part 21a and the non-transparent part 21b is detected by the boundary detection sensor 73, thereby forming the image 9 at a target position on the non-transparent part 21b.

Next, still another embodiment is explained by using FIG. 18. According to the present embodiment, as the boundary detection sensor 73, a photosensor using reflected light is used. In this case, by using the fact that the reflectance of the transparent part and the reflectance of the non-transparent part are different from each other, the boundary portion T3 between the transparent part 21a and the non-transparent part 21b can be detected.

The present invention is not restricted to the embodiments, and can be variously modified within a scope not deviating from the gist of the present invention. In the first to second embodiments, the non-transparent part 21b to the recording medium 21 is white. However, in the case of outputting a monotone image rather than a full-color photographic image, the color is not restricted to white.

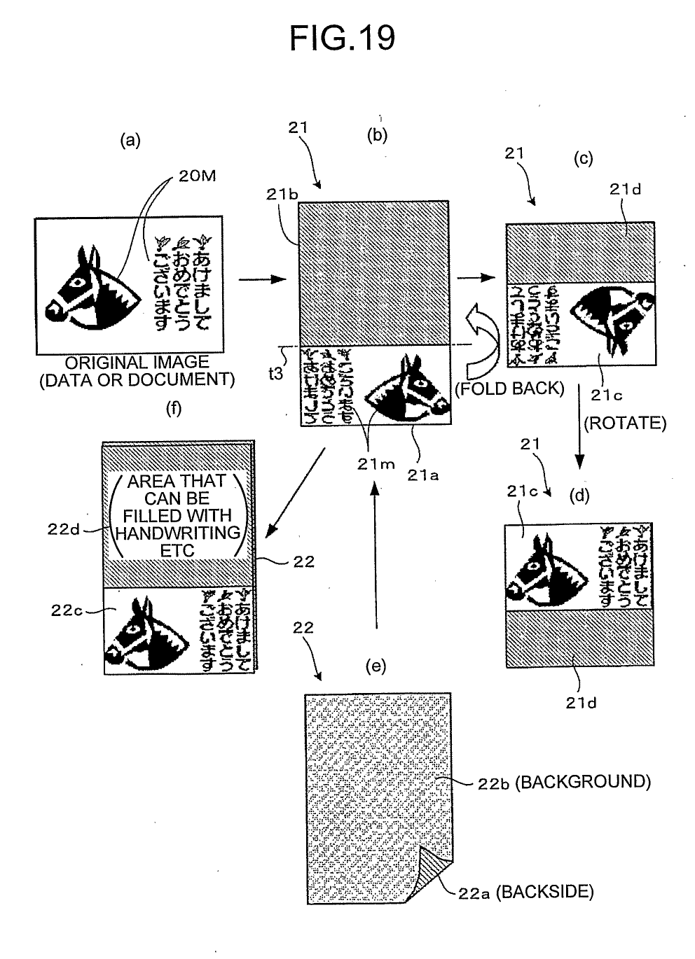

With reference to FIG. 19, the case where a new year greeting card with a glossy image is created is explained, according to a third embodiment of the present invention. FIG. 19 (a) depicts an original color image 20M including characters and illustrations. As the original image, the one written on the document or data stored in a storage unit, such as a hard disk, may be used.

For example, by using the image forming apparatus explained further below, as shown in FIG. 19 (b), a recording image (toner image) 21m based on the original image 20M is formed on the recording medium 21, which is a sheet-like medium. Here, the recording medium 21 includes the transparent part 21a and the non-transparent part 21b that are foldable. In the present example, the area of the transparent part 21a is smaller than that of the non-transparent part 21b. Where the recording image 21m is formed is a surface on a side of the transparent part 21a that is superposed on the non-transparent part 21b (functioning as a superposing medium) by folding. In other words, the image forming surface of the transparent part 21a is backed by the non-transparent part 21b. The image on the transparent part 21a is a mirror image of the original image 20M with its front and back being reversed.

Also, as required, the size of the image can be enlarged or reduced with respect to the original image. Here, when the original data is creased as a mirror image, the image is formed as it is on the transparent part 21a. Since the color, pattern, and others of the non-transparent part 21b on the same surface of the recording image 21m have an influence on the background of the finished image when an adhesive explained further below is transparent, an appropriate design is made in view of such an influence.

The transparent part 21a is folded along the boundary portion T3 between the transparent part 21a and the non-transparent part 21b with the image forming surface having the recording image 21m formed thereon being inside. At this folding back, an adhesive is applied in advance to an area that is on an upper surface of the non-transparent part 21b and is to be superposed on the transparent part 21a (or the image forming surface).

This adhesive layer forms the background of the finished image, unless it is water clear. If this adhesive layer is water clear, the non-transparent part 21b forms the background of the finished image. To reflect the non-transparent part 21b on the background of the finished image, the adhesive layer is selected as transparent. If the background of the finished image is determined irrespectively of the color, patterns, and others of the non-transparent part 21b, the adhesive layer is selected as non-transparent. In most cases, if white, which is a general color as a background color, is usually prepared, it will be possible to support various types of images.

The non-transparent part 21b together with the transparent part 21a passes through the fixing roller unit and is conveyed by the conveyor roller. Therefore, if the adhesive is applied from the start and exposed, it will adhere to the conveyor roller or the like, thereby causing an inappropriate situation in conveyance inside the image forming apparatus. To get around this, the adhesive can be applied after passing through the image forming apparatus and at the time of superposing with the transparent part 21a. Alternatively, if the adhesive is applied in advance, a heat-resistant label can be placed for protection on the surface to which the adhesive is applied in consideration of the passing of a heat fixing unit, and the heat-resistant label is then peeled off at the time of superposing with the transparent part 21a. Still alternatively, by using a heat-sensitive adhesive, adhesiveness can appear after passing through the heat fixing unit at the last process.

By folding the transparent part 21a, the transparent part 21a is integrated with the non-transparent part 21b via the adhesive. In this example, since the area of the transparent part 21a is large than that of the non-transparent part 21b, as shown in FIG. 19 (c), on the non-transparent part 21b, a superposing portion 21c superposed with the folded transparent part 21a and a margin portion 21d are produced. That is, the non-transparent part 21b is also a superposing medium. On the superposing portion 21c, the transparent part 21a is seen through to allow the same image as the original image (not a mirror image) to be viewed. In the state shown in FIG. 19 (c), the image is upside down. Therefore, if the recording medium 21 is vertically reversed, it can be known as shown in FIG. 19 (d) that the normal image can be viewed. The margin portion 21d can be used as a space for handwriting a message or the like.

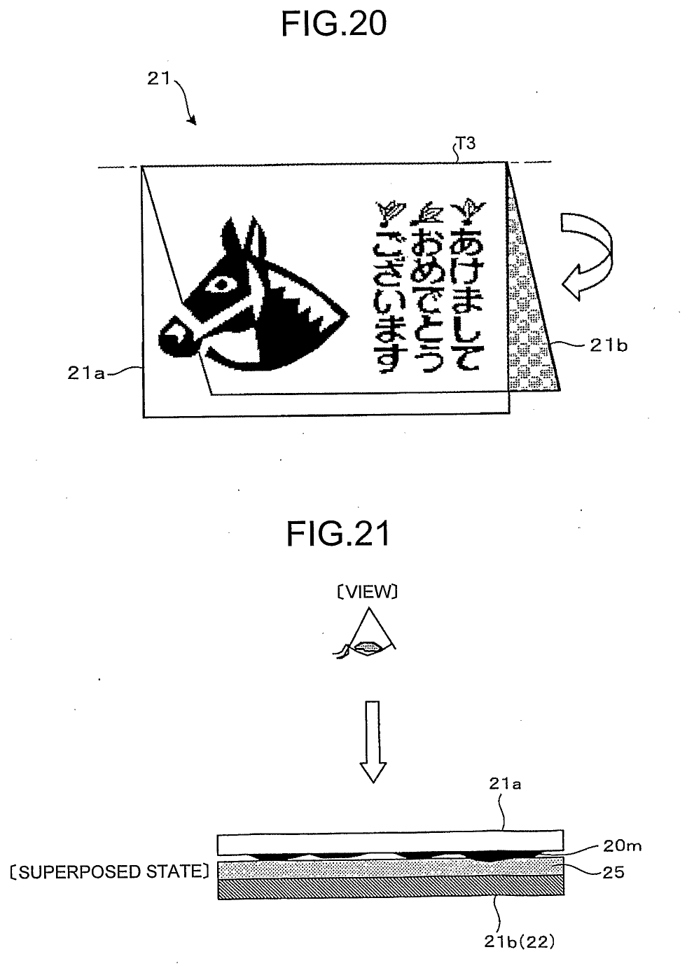

As shown in FIG. 19 (b), if a boundary portion O-O between the transparent part 21a and the non-transparent part 21b is not at a position where these two parts are unequally divided, but is at a position where the transparent part 21a and the non-transparent part 21b are equal in size to each other as shown in FIG. 20, the recording medium 21 after integration via the adhesive after folding becomes an image recording medium with an image on its entire surface without a margin for filling handwriting information.

The example is identical to the first image recording medium manufacturing method as shown in FIG. 19 (b) until the recording image 21m based on the original image 20M is formed on the transparent part 21a of the recording medium 21. Next, as shown in FIG. 19 (e), a superposing medium 22 is prepared having a sheet-like shape and being equal in size to the recording medium 21. One surface 22a of the superposing medium 22 is a surface serving as a back of the final image recording medium, and “the other one surface 22b” is a surface that can be a background of the recording medium 21m. “The other one surface 22b” or the image forming surface of the recording medium 21 has formed thereon in advance a white or transparent adhesive layer.

The superposing medium 22 in FIG. 19 (e) is superposed so that “the other one surface 22b” faces the recording image 21m of FIG. 19 (b). With this, the superposing medium 22 is integrated with the recording medium 21 via the adhesive layer. By flipping this integrated sheet to the back, as shown in FIG. 19 (f), as with the first method, the image recording medium having a glossy image can be formed. That is, in a superposing portion 22c, the transparent part 21a is seen through to allow a normal image (not a mirror image) identical to the original image to be viewed. Also, the back surface of the non-transparent part 21b shown in FIG. 19 (b) becomes a margin portion 22d, wherein necessary information can be filled in later by handwriting, for example.

A section of thus manufactured image recording medium is as shown in FIG. 21. Since the transparent part 21a and the non-transparent part 21b (the superposing medium 22) are integrally formed via an adhesive layer 25 and the recording image 21m is covered with the transparent part 21a, excellent keeping quality can be achieved. Also, since the surface of the transparent part 21a is glossy, the image can be seen as a photographic-tone image with a gloss.

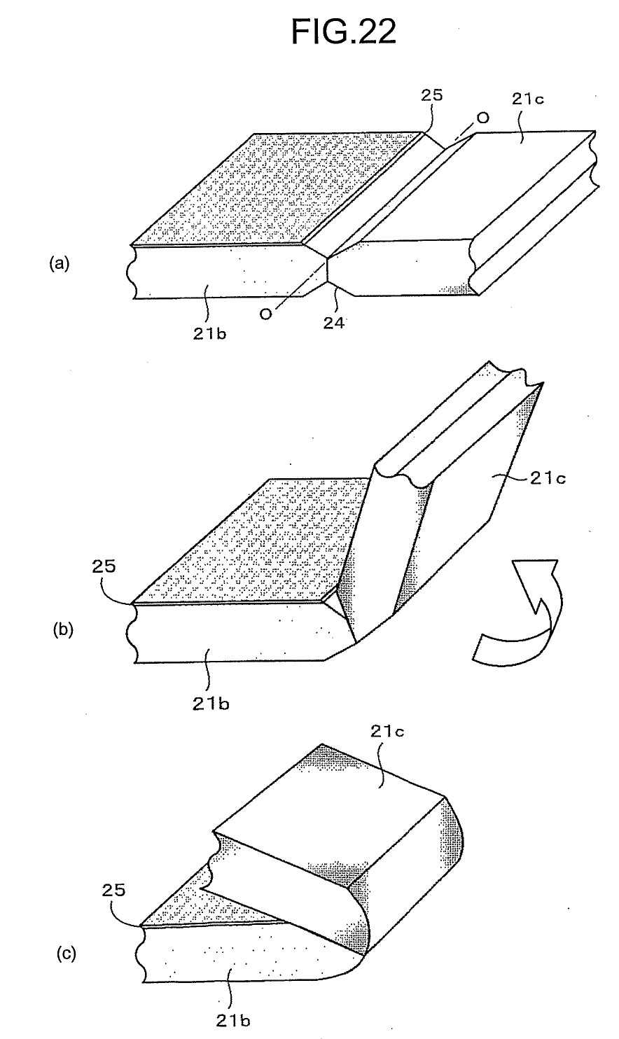

In the image recording medium manufacturing method, a folding-back portion at which the transparent part 21a is folded is the boundary portion T3 between the transparent part and the non-transparent part of the recording medium. With this, the image on the transparent part 21a can be sufficiently displayed as a glossy image. Also, as a unit of folding back neatly, a linear concave portion (see FIG. 22) can be formed on the recording medium 21 along the boundary portion T3.

In FIG. 22 (a), concave lines 23 and 24 with their section being in a V shape are formed on both sides of the boundary portion T3 in a thickness direction so as to face each other. Such a line may be formed only on one side. With such concave portion being formed, the folding portion is specified, and folding can be performed easily and neatly. Also, in place of formation of the concave portion, perforations can be formed to achieve similar advantages.

Here, the configuration and operation of an image forming apparatus according to the present embodiment is similar to those of FIG. 1. Therefore, redundant explanation is omitted herein.

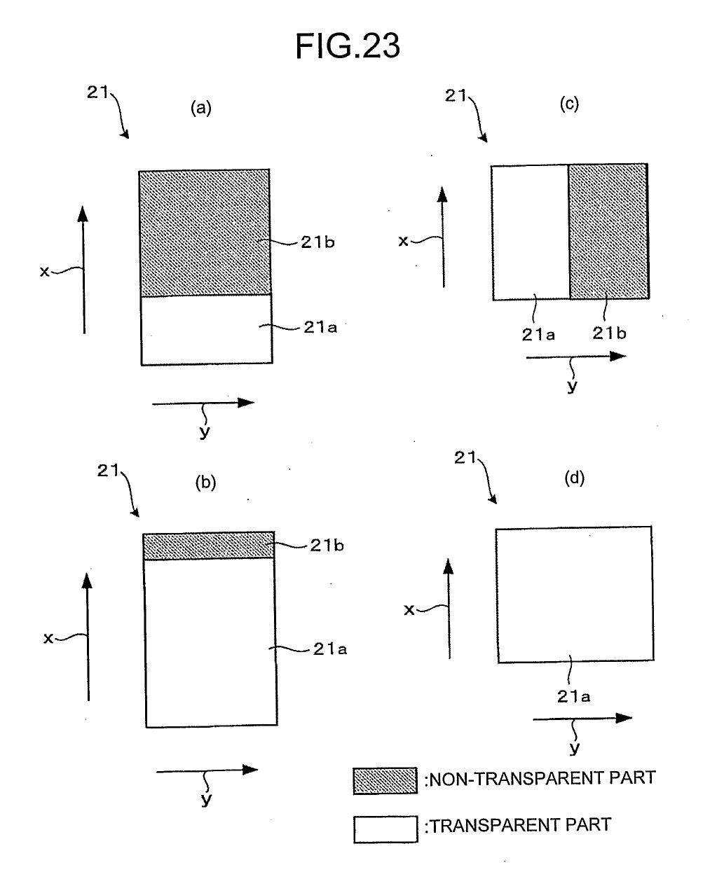

When the present invention is implemented, in the image forming apparatus shown in FIG. 1, as the transfer sheet 100, a recording medium at least part of which has a transparent part as shown in FIGS. 23 (a) to (d) is used. Then, with light from the optical writing unit 3, an image corresponding to the original image is written on the photosensitive drum 11, is developed with color toner, and further transferred onto the transparent part of the recording medium. This recording medium is delivered to the paper delivery tray 8. Writing of the image by the optical writing unit 3 is performed so that the image obtained by reversing the original image is formed on the transparent part 21a of the recording medium 21. The original image data can be input from an external device connected to the image forming apparatus. Alternatively, image information read by a scanner not shown that comes with the image forming apparatus can be used.

Various examples with different ratios between the transparent part and the non-transparent part are shown in FIG. 23. In the recording medium 21 shown in FIG. 23 (a), as with FIG. 19 (b), the transparent part 21a is smaller than the non-transparent part 21b. In the recording medium 21 shown in FIG. 23 (b), the transparent part 21a is larger than the non-transparent part 21b. In the recording medium 21 shown in FIG. 23 (c), the transparent part 21a is equal to the non-transparent part 21b. In the recording medium 21 shown in FIG. 23 (d), the entire part is the transparent part 21a. The direction of conveying any of these recording media 21 can be selected as either x or y.

Schemes of setting in the image forming apparatus a condition in which the recording medium at least part of which is transparent is allowed to pass through include a scheme of making an instruction in advance by the user with settings of the paper feeding unit (the paper feeding cassette 4a), and a scheme of registering in advance a transparent area (the transparent part 21a) of a specific size in the control unit of the image forming apparatus.

After the transparent area is defined, when it is determined that an image is to be formed at least on this defined transparent area, the image is formed as being automatically reversed. As a result, on the recording medium after passing through the fixing unit 7, the reversed image is formed at least on the transparent part 21a.

The recording medium obtained above is superposed on the white superposing medium with the print surface (image forming surface) down, thereby easily obtaining a photographic-tone image. With the print surface (image forming surface) down and being caught by the white superposing medium, the print surface is not directly damaged from the outside, thereby achieving excellent keeping quality. With the reversed image being formed on the transparent area, image components (toner image) is in intimate contact with the transparent base material.

In general, data, such as characters and images, which can be recorded on the transparent part is not unified based on a fixed size or resolution. Adjusting images of different sizes one by one to the size of the transparent area and reversing them for output is an extremely cumbersome task.

According to the third embodiment, a series of operations of automatically enlarging or reducing the size of the image to be output to an appropriate size according to the area defined as transparent by the image forming apparatus and performing a reversing operation can be automatically performed. Differences are schematically explained in the following a (conventional technology) and b (present embodiments), by taking general image forming apparatuses, such as copiers or printers, as examples.

a: When a reversed image is formed through a manual operation on a recoding medium at least part of which is transparent

(1) Image selection

(2) Change in size of the image data (enlargement or reduction in consideration of the resolution and the transparent area size)

(3) Reversal of the image data

(4) Alignment of the image data (in consideration of a non-transparent part, the image data is moved to the transparent area)

(5) Instruction for print

In the operations (2) and (3) above, in general, a dedicated application software is separately required.

Normally, every time the image data is changed and every time the condition of the transparent area is changed, adjustment is required.

b: When an automatic operation is performed according to the present embodiment

(1) The user makes an instruction for printing, such as “photographic-tone print” on the transparent area. This instruction can be made through a setting button on a copier or a setting icon on a driver of a printer.

(2) Select an image

(3) Instruction for print (the image is automatically and appropriately enlarged or reduced according to the transparent area, and is reversed for image formation)

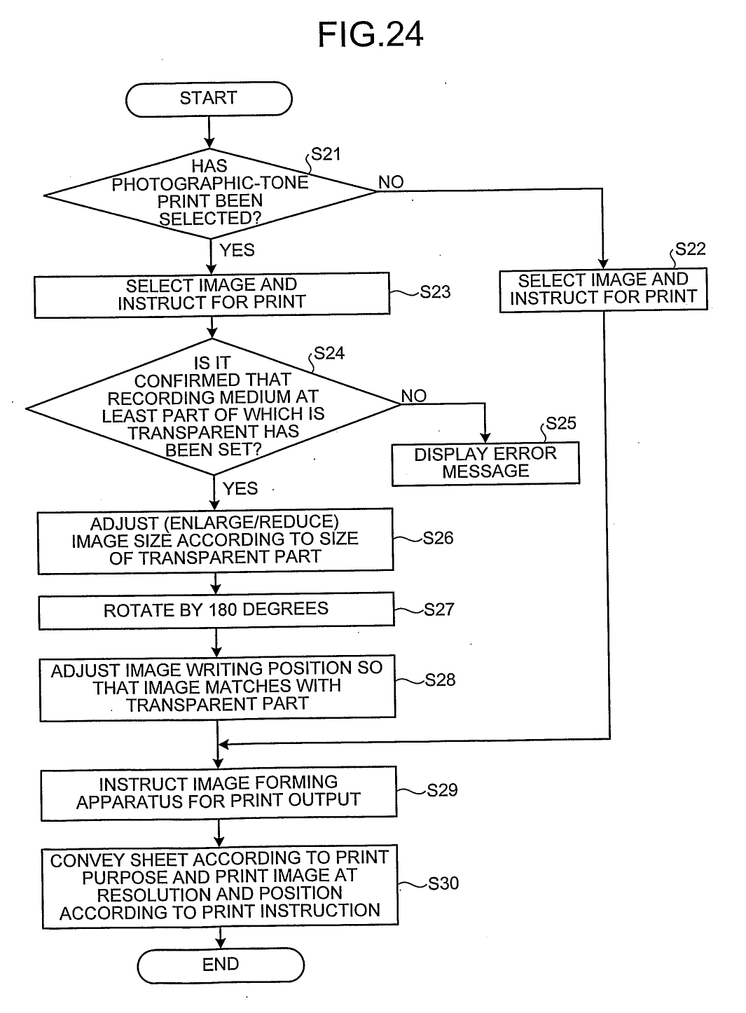

Image formation on the transparent part by the image forming apparatus is performed by a program on the control unit provided to the image forming apparatus, through the procedure shown in FIG. 24 including image formation on the transparent part of the recording medium. That is, if it is determined at step S21 that photographic-tone print has not been selected, the procedure goes to step S22, where an image to be printed is selected and a print instruction is made. Next, at step S29, the image forming apparatus is instructed for print output. At step S30, a sheet (recording medium) according to a print purpose is conveyed, and image print at a resolution and position according to the print instruction is performed.

If it is determined at step S21 that photographic-tone print has been selected, the procedure goes to step S23, where an image to be printed is selected and a print instruction is made. At step S24, it is checked whether a recording medium at least part of which has a transparent part has been set in a paper feeding cassette or the like. If NO, an error message is displayed at step S25. On the other hand, if YES, the procedure goes to step S26, where the size of the image to be formed on the transparent part 21a is adjusted through enlargement, reduction, and others according to the size of the transparent part.

At step S27, to form a front-and-back-reversed image on the transparent part 21a, image data is processed so as to form a reversed image. At step S28, an image writing position is adjusted so that the image matches with the transparent part 21a. Thereafter, the procedure goes to step S29.

In this manner, by the control unit, image formation with the original image being reversed is performed on the transparent part of the recording medium.

### INDUSTRIAL APPLICABILITY

As has been explained above, the image forming apparatus, image forming system, paper feeding apparatus, image recording medium, and image recording medium manufacturing method according to the present invention are useful for image forming apparatuses, for example, copiers or laser printers and, in particular, are suitable for apparatuses, systems, recording medium manufacturing methods and others in which the original image is automatically reversed on a transparent recording medium.

1-20. (canceled)

21. An image forming apparatus comprising:
a conveyer path through which a recording medium is conveyed, the recording medium including a non-transparent recording medium and a transparent recording medium at least a part of which is transparent;
an image forming unit that forms an image on the recording medium;
a recording-medium selecting unit that selects either one of the non-transparent recording medium and the transparent recording medium, and conveys a selected recording medium to the conveyer path;
an image selecting unit that selects an image to be formed on the recording medium from among an original image and a reversed image obtained by reversing the original image; and
a control unit that controls, based on a first control signal, the recording-medium selecting unit to select the transparent recording medium and the image selecting unit to select the reversed image, to form the reversed image on the transparent recording medium, and controls, based on a second control signal, the recording-medium selecting unit to select the transparent recording medium and the image selecting unit to select no image.

22. The image forming apparatus according to claim 21, further comprising:
at least one paper feeding tray that separately stocks the non-transparent recording medium and the transparent recording medium, wherein
the recording-medium selecting unit conveys the selected recording medium in the paper feeding tray to the conveyer path depending on a selection of the non-transparent recording medium or the transparent recording medium.

23. The image forming apparatus according to claim 21, further comprising:
a recording-medium detecting unit that detects whether the recording medium is the non-transparent recording medium or the transparent recording medium, wherein
the recording-medium selecting unit conveys the selected recording medium to the conveyer path when the selected recording medium matches with detected recording medium.

24. The image forming apparatus according to claim 21, wherein the control unit controls the recording-medium selecting unit to select a non-transparent white recording medium before and after controlling the recording-medium selecting unit to select the transparent recording medium based on the first control signal, to convey the non-transparent white recording medium to the conveyer path before and after the transparent recording medium on which the reversed image is formed is conveyed to the conveyer path.

25. The image forming apparatus according to claim 24, further comprising:
a delivering unit that delivers the recording medium conveyed through the conveyer path to outside, wherein
the control unit controls the delivering unit to deliver the non-transparent white recording medium to the outside before and after delivering the transparent recording medium on which the reversed image is formed to the outside.

26. The image forming apparatus according to claim 24, further comprising:
a bonding unit that bonds a pair of recording media, wherein
the control unit controls the bonding unit to bond the non-transparent white recording medium onto a surface of the transparent recording medium on which the reversed image is formed.

27. The image forming apparatus according to claim 21, further comprising:
an operating unit that generates the first control signal.

28. An image forming system comprising:
the image forming apparatus according to claim 21; and
an external apparatus that communicates with the image forming apparatus, wherein
the external apparatus transmits the first control signal to the image forming apparatus.

29. A paper feeding apparatus comprising:
a pair of resist rollers for conveying a recording medium having a transparent part and a non-transparent part, and aligns the recording medium at a predetermined timing; and
a boundary detection sensor that detects a boundary between the transparent part and the non-transparent part, wherein
the boundary detection sensor is provided at a downstream position in a direction in which the resist rollers convey the recording medium.

30. The paper feeding apparatus according to claim 29, wherein the non-transparent part is white.

31. An image forming apparatus comprising:
the paper feeding apparatus according to claim 29; and
an image forming unit that forms an image on the recording medium, wherein
the boundary detection sensor is provided at a downstream position in a direction in which the resist rollers convey the recording medium, and
the recording medium is folded along the boundary between the transparent part and the non-transparent part so that the transparent part and the non-transparent part are superposed each other.

32. The image forming apparatus according to claim 31, wherein the image forming unit forms a reversed image obtained by horizontally reversing or vertically reversing an original image on the transparent part.

33. An image recording medium comprising:
a recording medium that is a sheet-like medium on which an image is formed by an image forming apparatus, at least a part of the recording medium being transparent;
a superposing medium that is superposed on a transparent part of the recording medium; and
an adhesive layer on which an adhesive is applied, wherein
the superposing medium is bonded onto an image forming surface of the transparent part via the adhesive layer.

34. The image recording medium according to claim 33, wherein the adhesive layer is transparent or white.

35. The image recording medium according to claim 33, wherein a reversed image obtained by reversing an original image is formed on a surface of the transparent part on which the superposing medium is superposed.

36. The image recording medium according to claim 33, wherein a surface of the transparent part on which the superposing medium is superposed is a smooth surface.

37. An image forming apparatus comprising:
a conveyer path through which the image recording medium according to claim 33 is conveyed;
an image forming unit that forms an image on the recording medium; and
a control unit that controls, when the image is formed on the transparent part of the recording medium, to form a reversed image obtained by reversing an original image.

38. A method of creating an image recording medium according to claim 33, the method comprising:
forming an image on a transparent part of the recording medium; and
bonding a sheet-like superposing medium onto an image forming surface of the transparent part via an adhesive.

39. The method according to claim 38, wherein the bonding includes
folding the image forming surface of the transparent part inside, and
bonding the image forming surface onto the recording medium via the adhesive.

40. The method according to claim 38, wherein the image formed on the transparent part is a reversed image obtained by reversing an original image.
